(19) United States
(12) Patent Application Publication
(10) Pub. No.: US 2014/0145814 A1
(43) Pub. Date: May 29, 2014

(54) THIN FILM TYPE CHIP DEVICE AND METHOD OF MANUFACTURING THE SAME

(71) Applicant: SAMSUNG ELECTRO-MECHANICS CO., LTD., Suwon-si (KR)

(72) Inventors: Sang Moon LEE, Suwon-si (KR); Jun Hee BAE, Suwon-si (KR); Sung Kwon WI, Suwon-si (KR); Yong Suk KIM, Suwon-si (KR)

(73) Assignee: SAMSUNG ELECTRO-MECHANICS CO., LTD., Suwon-si (KR)

(21) Appl. No.: 14/086,152

(22) Filed: Nov. 21, 2013

(30) Foreign Application Priority Data
Nov. 23, 2012 (KR) 10-2012-0133667

(51) Int. Cl. H01F 27/28

(52) U.S. Cl. CPC H01F 27/2804
USPC 336/200; 427/258

(57) ABSTRACT

Disclosed herein is a thin film type chip device including a coil pattern formed on the substrate; a cavity defining pattern defining a cavity through which a part of the coil pattern is exposed; a filling layer filled in the cavity; and a magnetic layer including a surface layer covering a surface of the filling layer.

### CROSS REFERENCE(S) TO RELATED APPLICATIONS

This application claims the benefit under 35 U.S.C. Section 119 of Korean Patent Application Serial No. 10-2012-0133667, entitled “Thin Film Type Chip Device and Method of Manufacturing the Same” filed on Nov. 23, 2012, which is hereby incorporated by reference in its entirety into this application.

### BACKGROUND OF THE INVENTION

1. Technical Field

The present invention relates to a thin film type chip device and a method of manufacturing the thin film type chip device, and more particularly, to a thin film type chip device capable of preventing an appearance from being poor during a manufacturing process and improving permeability and impedance characteristics and a method of manufacturing the thin film type chip device.

2. Description of the Related Art

Recently, as electronic devices such as smart phones have been equipped with high specifications, multi functions, and small sizes, it is essential to apply chip parts to these electronic devices so as to remove common mode noise from a circuit such as a high speed interface using a differential transmission. To meet this, a thin film type common mode noise filter (CMF) capable of being high functional and small size is being developed.

A general process of manufacturing the thin film type CMF largely includes operations of forming a coil pattern on a ferrite substrate, forming an electrode pattern, on the coil pattern, defining a cavity through which a part of the coil pattern is exposed, and filling the cavity with ferrite fillers. The filling operation is performed to increase permeability and impedance characteristics of the CMF. The greater the sizes of ferrite particles in the fillers, the higher the permeability of chip parts.

However, if sizes of ferrite particles of a ferrite magnetic layer increase, a phenomenon that the ferrite particles come away from a surface of a filling layer occurs during a process of manufacturing the chip parts. Such a phenomenon of the ferrite particles causes generation of pores in irregular shapes on a surface of the ferrite magnetic layer. In particular, the frequency of generation of such pores highly increases in a case where sizes of the ferrite particles exceed 45 μm. The ferrite magnetic layer is an element involving permeability and is exposed to the outside, and thus such a generation of pores deteriorates the permeability and impedance characteristics of the chip parts, and causes a poor appearance.

### RELATED ART DOCUMENT

### Patent Document

### (Patent Document 1) Korean Patent Laid-Open Publication No. 10-2009-0078245

### SUMMARY OF THE INVENTION

An object of the present invention is to provide a thin film type chip device that improves permeability and impedance characteristics.

Another object of the present invention is to provide a thin film type chip device that prevents permeability and impedance characteristics from deteriorating due to a phenomenon that ferrite particles come away from a surface of a ferrite magnetic layer.

Another object of the present invention is to provide a thin film type chip device that improves permeability and impedance characteristics and maintains a good appearance.

Another object of the present invention is to provide a method of manufacturing a thin film type chip device that prevents permeability and impedance characteristics from deteriorating due to a phenomenon that ferrite particles come away from a surface of a ferrite magnetic layer.

According to an exemplary embodiment of the present invention, there is provided a thin film type chip device including: a substrate; a coil pattern formed on the substrate; a cavity defining pattern defining a cavity through which a part of the coil pattern is exposed; a filling layer filled in the cavity; and a surface layer covering a surface of the filling layer.

The filling layer may include a pore formed in a surface adjacent to the surface layer, and the surface layer may be filled in the pore.

The filling layer and the surface layer may have magnetic particles of the same type, and a size of the magnetic particle of the surface layer may be the same as the size of the magnetic particle of the filling layer.

The filling layer and the surface layer may have magnetic particles of the same type, and a size of the magnetic particle of the surface layer may be smaller than the size of the magnetic particle of the filling layer.

Each of the filling layer and the surface layer may have magnetic particles of the same type, and sizes of the magnetic particles may be from 20 μm and 45 μm.

A thickness of the surface layer may be equal to and smaller than 100 μm.

A thickness of the surface layer may be equal to and smaller than 80 μm.

The substrate may be a ferrite magnetic substrate, and the coil pattern may have a multilayer structure.

A surface of the surface layer may be coplanar with a surface of the cavity defining pattern.

The cavity defining pattern may be an external electrode electrically connected to the coil pattern.

According to another exemplary embodiment of the present invention, there is provided a method of manufacturing a thin film type chip device, the method including: preparing a substrate; forming a coil pattern on the substrate; forming a cavity defining pattern defining a cavity through which a part of the coil pattern is exposed on the substrate; forming a filling layer filled in the cavity; and forming a surface layer on the filling layer.

The forming of the surface layer may include: filling a pore formed in a surface of the filling layer.

The forming of the filling layer may include: filling a first filler in the cavity; and planarizing the first filler by using the cavity defining pattern as a polishing stop layer, and the forming of the surface layer may include: forming a second filler on the filling layer; and planarizing the second filler by using the cavity defining pattern as a polishing stop layer.

The filling layer and the surface layer may include magnetic particles having sizes from 20 μm to 45 μm, and the magnetic particle of the filling layer may use a ferrite particle having the same size as the size of the magnetic particle of the surface layer.

The filling layer and the surface layer may include magnetic particles having sizes from 20 μm to 45 μm, and the magnetic particle of the filling layer may use a ferrite particle having a size smaller than the size of the magnetic particle of the surface layer.

The preparing of the substrate may include: preparing a ferrite substrate, and the forming of the coil pattern on the substrate may include: forming a first pattern on the substrate; and stacking a second pattern on the first pattern.

The forming of the surface layer on the filling layer may be performed by allowing a surface of the surface layer to be coplanar with a surface of the cavity defining pattern.

### BRIEF DESCRIPTION OF THE DRAWINGS

FIG. 1 is a cross-sectional view of a thin film type chip device according to an embodiment of the present invention;

FIGS. 2 and 3 are expanded views of an area A of FIG. 1;

FIG. 4 is a flowchart showing a method of manufacturing a thin film type chip device according to an embodiment of the present invention; and

FIGS. 5 through 7 are cross-sectional views for explaining a method of manufacturing a thin film type chip device according to an embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a thin film type chip device and a method of manufacturing the a thin film type chip device according to the embodiments of the present invention will now be described in detail with reference to accompanying drawings below.

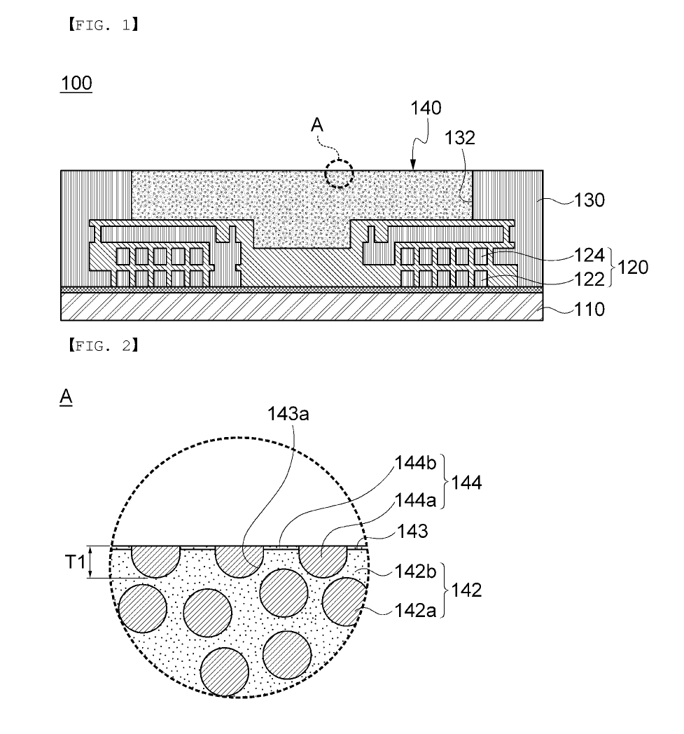

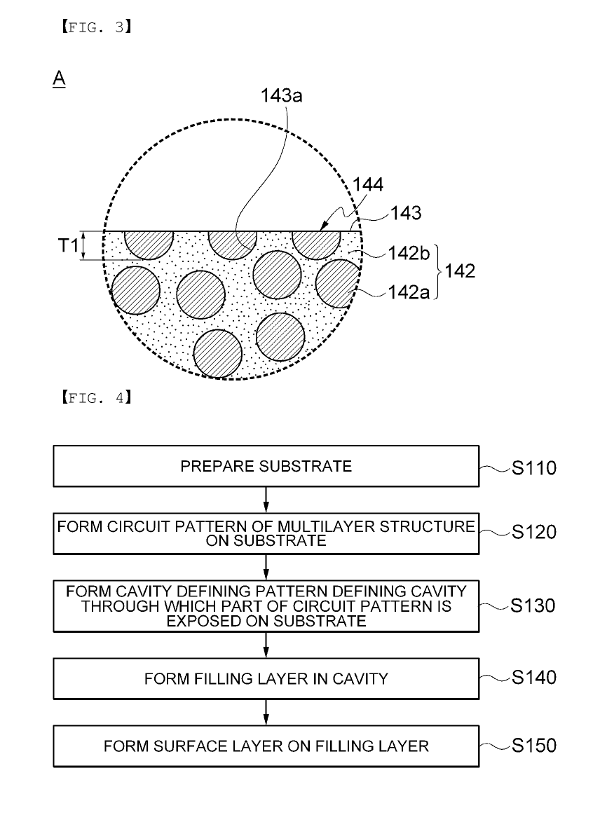

FIG. 1 is a cross-sectional view of a thin film type chip device 100 according to an embodiment of the present invention. FIGS. 2 and 3 are expanded views of an area A of FIG. 1.

Referring to FIG. 1, the thin film type chip device 100 according to an embodiment of the present invention may be chip parts that is employed in a predetermined electronic device and filters specific noise. As an example, the thin film type chip device 100 may be a common mode noise filter (CMF) that is included in an electronic device such as a smart phone and removes common mode noise.

The thin film type chip device 100 may include a substrate 110, a coil pattern 120, a cavity defining pattern 130, and a magnetic layer 140.

The substrate 110 may be a base for manufacturing the thin film type chip device 100. A ferrite magnetic substrate may be used as the substrate 110.

The coil pattern 120 may have a multilayer structure. For example, the coil pattern 120 may consist of a first coil 122 and a second coil 124 stacked on the first coil 122. The first and second coils 122 and 124 may be electrically connected to each other to form a coil shape of a dual-layer structure.

The cavity defining pattern 130 may define a cavity 132 through which a partial area of the coil pattern 120 is exposed on the substrate 110. The cavity defining pattern 130 may be formed on a boundary area of the substrate 110 in such a manner that the cavity 132 may be provided in a central area of the coil pattern 120. The cavity defining pattern 130 may be a metal pattern electrically connected to the coil pattern 120. In this case, the cavity defining pattern 130 may be used as an external electrode for electrically connecting the thin film type chip device 100 to an external device.

The magnetic layer 140 may be formed by filling a predetermined filler in the cavity 132 in order to increase permeability and impedance characteristics of the thin film type chip device 100. The filler may be a resin composition containing predetermined magnetic particles.

The magnetic layer 140 may consist of a filling layer 142 and a surface layer 144 covering a surface of the filling layer 142. The filling layer 142 occupies a major portion of the cavity 132 to have a great thickness, whereas the surface layer 144 may be provided to cover the filling layer 142 with a small thickness. The filling layer 142 may have a surface (hereinafter referred to as an “upper surface”) 143 adjacent to the surface layer 144. A pore 143a may be formed in the upper surface 143. The pore 143a may be plural and may be generated by allowing magnetic particles to come away from the upper surface 143 during a process of manufacturing the thin film type chip device 100. The surface layer 144 may fill the pore 143a to prevent a function of the magnetic layer 140 from deteriorating due to the pore 143a.

Meanwhile, the filling layer 142 may be formed by filling a filler including a first magnetic particle 142a and a first resin 142b in the cavity 132. The first magnetic particle 142a may be a ferrite magnetic particle. The first resin 142b may be an epoxy resin. The surface layer 144 may be formed by forming a filler including a second magnetic particle 144a and a second resin 144b on the upper surface 143 of the filling layer 142. A composition of the surface layer 144 may be generally same as a composition of the filling layer 142. That is, the second magnetic particle 144a may be a magnetic particle of the same type selected from a variety of magnetic particles and the first magnetic particle 142a, for example, a ferrite particle. The second resin 144b may be an epoxy resin.

Sizes of the first and second magnetic particles 142a and 144a contained in the filler may be adjusted in various ways. For example, the first and second magnetic particles 142a and 144a may have sizes approximately from 20 μm to 45 μm. In a case where the sizes of the the first and second magnetic particles 142a and 144a are equal to and smaller than 20 μm, a high frequency characteristic of the thin film type chip device 100 may be improved, whereas a permeability characteristic may be remarkably reduced. Also, In a case where the sizes of the the first and second magnetic particles 142a and 144a are equal to and smaller than 20 μm, it is very difficult to handle particles, which may deteriorate manufacturing processibility of the filler. On the other hand, in a case where the sizes of the the first and second magnetic particles 142a and 144a are equal to and greater than 45 μm, the permeability characteristic may increase, whereas the high frequency characteristic may deteriorate. In particular, a particle exfoliation phenomenon that the magnetic particles come away from the surface of the magnetic layer 140 may dramatically occur. Thus, the sizes of the magnetic particles may be adjusted approximately from 20 μm to 45 μm. However, the sizes of the the first and second magnetic particles 142a and 144a may be preferably maximized in terms of the permeability provided that the pore 143a is not generated. Therefore, the sizes of the the first and second magnetic particles 142a and 144a may be more preferably adjusted closer to approximately 45 μm.

Also, the size of the second magnetic particle 144a may be the same as or smaller than the size of the first magnetic particle 142a. As an example, the size of the second magnetic particle 144a may be generally the same as the size of the first magnetic particle 142a. The pore 143a is generated as the first magnetic particle 142a comes away from the upper surface 143 of the filling layer 142, and thus a size of the pore 143a may be somewhat small or great with respect to the size of the first magnetic particle 142a. The actual size of the pore 143a may be diverse from 10 μm to 80 μm. Thus, assuming that the size of the pore 143a is equal to or greater than approximately 20 μm, in a case where the size of the second magnetic particle 144a is the same as the size of the first magnetic particle 142a and is filled in the pore 143a, since the magnetic layer 140 has magnetic particles having the same size, the filling layer 142 and the surface layer 144 may function as the single complete magnetic layer 140.

Alternatively, as another example, the second magnetic particle 144a may have a small particle compared to the first magnetic particle 142a. In this case, the size of the second magnetic particle 144a may be smaller than the size of the pore 143a, filling efficiency of the second magnetic particle 144a with respect to the pore 143a may be improved. However, in a case where the size of the second magnetic particle 144a is remarkably small, since the permeability characteristic of the thin film type chip device 100 may deteriorate, the size of the second magnetic particle 144a may preferably remain equal to and greater than at least 20 μm. As an example, in a case where an average diameter of the first magnetic particle 142a is from 40 μm to 45 μm, an average diameter of the second magnetic particle 144a may be adjusted approximately from 20 μm to 40 μm.

A thickness of the surface layer 144 may be equal to and smaller than approximately 100 μm. The surface layer 144 is used to fill the pore 143a with the second magnetic particle 144a, and thus the surface layer 144 may be preferably provided with a minimum thickness while satisfying the condition of filling the pore 143a. As an example, as shown in FIG. 2, the surface layer 144 may cover the upper surface 143 of the filling layer 142 with a certain thickness as well as fill the pore 143a. In this case, since the size of the pore 143a is approximately from 10 μm to 80 μm, a thickness T1 of the surface layer 144 may be equal to and smaller than approximately 100 μm. As another example, as shown in FIG. 3, the surface layer 144 may be provided by selectively filling only the pore 143a. In this case, the thickness T1 of the surface layer 144 may be equal to and smaller than approximately 80 μm.

Also, the surface of the surface layer 144 may have approximately the same height as that of the surface of the cavity defining pattern 130. As an example, the surface of the surface layer 144 and the surface of the cavity defining pattern 130 may be complanar. The surface layer 144 fills the pore 143a to have a smooth surface while sharing the same surface with the cavity defining pattern 130, thereby implementing an aesthetically good appearance.

As described above, the the thin film type chip device 100 according to an embodiment of the present invention includes the cavity defining pattern 130 including the cavity 132 through which a part of the coil pattern 120 is exposed on the substrate 110 and the magnetic layer 140 filling the cavity 132. The magnetic layer 140 may include the filling layer 142 filling the cavity 132 for the most part and the surface layer 144 covering the upper surface 143 of the filling layer 142. The surface layer 144 fills the pore 143a generated in the upper surface 143 of the filling layer 142 with magnetic particles, thereby preventing the function of the magnetic layer 140 from deteriorating due to the pore 143a. Accordingly, the thin film type chip device 100 according to an embodiment of the present invention additionally covers the surface of the magnetic layer 140 with the surface layer 144, which prevents the function of the magnetic layer 140 from deteriorating due to the pore 143a generated in the surface of the magnetic layer 140, thereby improving the permeability and impedance characteristics and preventing the appearance from being poor.

Continuously, a method of manufacturing a thin film type chip device according to an embodiment of the present invention will now be described in detail. In this regard, a redundant description of the above-described thin film type chip device 100 will be omitted or briefed.

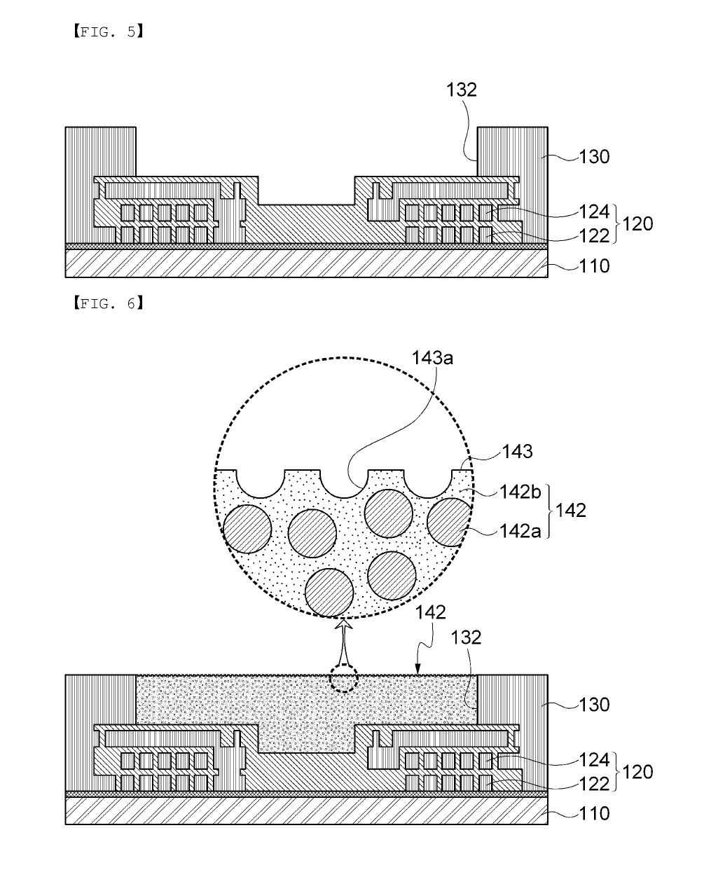

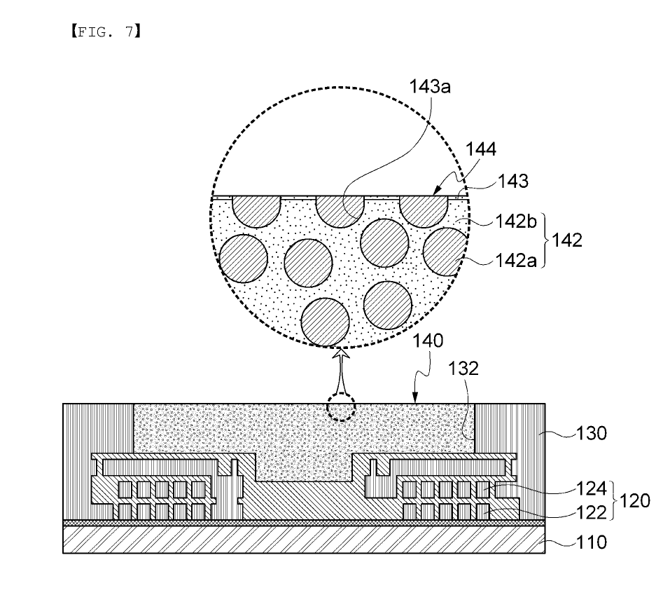

FIG. 4 is a flowchart showing a method of manufacturing a thin film type chip device according to an embodiment of the present invention. FIGS. 5 through 7 are cross-sectional views for explaining a method of manufacturing the thin film type chip device according to an embodiment of the present invention.

Referring to FIGS. 4 and 5, the substrate 110 may be prepared (S110). A substrate formed of a magnetic material may be used as the substrate 110. As an example, a ferrite magnetic substrate may be used as the substrate 110.

A coil pattern 120 of a multilayer structure may be formed on the substrate 110 (S120). For example, the first coil pattern 122 may be formed by performing photo resist and plating processes, and the second coil pattern 124 may be formed by performing the photo resist and plating processes on a resultant in which the first coil pattern 122 is formed. Although the circuit pattern 120 of a dual layer structure is described in the present embodiment, the number of layers of the circuit pattern 120 may be adjusted in various ways.

The cavity defining pattern 130 defining the cavity 132 through which a part of the circuit pattern 120 is exposed may be formed on the substrate 110 (S130). The operation of forming the cavity defining pattern 130 may be performed after forming a metal layer on a resultant in which the circuit pattern 120 is formed and selectively removing a part of the metal layer. The cavity defining pattern 130 may be used as an external electrode for electrically connecting the circuit pattern 120 to an external device.

Referring to FIGS. 4 and 6, the filling layer 142 may be formed in the cavity 132 (S140). The operation of forming the filling layer 142 may be performed by manufacturing a predetermined filler, filling the filler in the cavity 132, and planarizing the filler. The filler may be an epoxy resin composition consisting of the first magnetic particle 142a and the first resin 142b. A ferrite particle having a size approximately from 20 μm to 45 μm may be used as the first magnetic particle 142a. The operation of planarizing the filler may be performed by performing a polishing process that uses the cavity defining pattern 130 as a polishing stop layer with respect to the epoxy resin composition filled in the cavity 132. Accordingly, the filling layer 142 having a thickness that is approximately the same as a height of a surface of the cavity defining pattern 130 may be formed in the cavity 132.

Meanwhile, during the above-described polishing process, a phenomenon that the first magnetic particle 142a comes away from the upper surface 143 of the filling layer 142 may occur. Accordingly, the pore 143a may be formed in the surface of the filling layer 142. The pore 143a may have a depth approximately from 10 μm to 80 μm and may be irregularly distributed on the surface of the filling layer 142.

Referring to FIGS. 4 and 7, the surface layer 144 may be formed on the filling layer 142 (S150). The surface layer 144 may be used to fill the pores 143a formed in the surface 143 of the filling layer 142 with a magnetic substance. The operation of forming the surface layer 144 may be performed by manufacturing a surface processing material, forming the surface processing material on the surface 143 in a thin film form, and planarizing the surface processing material. The surface processing material may use an epoxy resin composition consisting of the second magnetic particle 144a and the second resin 144b.

The operation of planarizing the surface processing material may be performed by performing the polishing process that uses the cavity defining pattern 130 as the polishing stop layer with respect to the surface processing material. Accordingly, the surface layer 144 that is filled in the pore 143a, covers the filling layer 142 with a uniform thickness, and has a surface coplanar with the surface of the cavity defining pattern 130 may be formed on the filling layer 142.

As described above, the method of manufacturing the thin film type chip device according to an embodiment of the present invention may include the operations of forming the coil pattern 120 of the multilayer structure on the substrate 110, forming the cavity defining pattern 130 defining the cavity 132 on the substrate 110, and filling the magnetic layer 140 in the cavity 132. The operation of filling the magnetic layer 140 may include the operations of forming the filling layer 142 in the cavity 132 and additionally forming the surface layer 144 on the filling layer 142. The surface layer 144 may be used to prevent permeability and impedance characteristics from deteriorating due to the formation of the pore 143a by filling the pore 143a formed in the upper surface 143 with magnetic particles during the process of manufacturing the filling layer 142. Accordingly, the method of manufacturing the thin film type chip device according to the present invention additionally covers the surface of the magnetic layer 140 with the surface layer 144, which prevents a function of the magnetic layer 140 from deteriorating due to the pore 143a formed in the surface of the magnetic layer 140, and thus the thin film type chip device having a structure with the improved permeability and impedance characteristics and capable of preventing an appearance from being poor may be manufactured.

As described above, a thin film type chip device according to the present invention additionally covers a surface of a magnetic layer with a surface layer, which prevents a function of the magnetic layer from deteriorating due to pores generated on the surface of the magnetic layer, thereby improving permeability and impedance characteristics and preventing an appearance from being poor.

A method of manufacturing a thin film type chip device according to the present invention additionally covers a surface of a magnetic layer with a surface layer, which prevents a function of the magnetic layer from deteriorating due to pores generated on the surface of the magnetic layer, thereby manufacturing the thin film type chip device having a structure with improved permeability and impedance characteristics and capable of preventing an appearance from being poor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A thin film type chip device comprising:
a substrate;
a coil pattern formed on the substrate;
a cavity defining pattern defining a cavity through which a part of the coil pattern is exposed;
a filling layer filled in the cavity; and
a surface layer covering a surface of the filling layer.

2. The thin film type chip device according to claim 1, wherein the filling layer includes a pore formed in a surface adjacent to the surface layer, and
the surface layer is filled in the pore.

3. The thin film type chip device according to claim 1, wherein the filling layer and the surface layer have magnetic particles of the same type, and
a size of the magnetic particle of the surface layer is the same as the size of the magnetic particle of the filling layer.

4. The thin film type chip device according to claim 1, wherein the filling layer and the surface layer have magnetic particles of the same type, and
a size of the magnetic particle of the surface layer is smaller than the size of the magnetic particle of the filling layer.

5. The thin film type chip device according to claim 1, wherein each of the filling layer and the surface layer has magnetic particles of the same type, and
sizes of the magnetic particles are from 20 μm and 45 μm.

6. The thin film type chip device according to claim 1, wherein a thickness of the surface layer is equal to and smaller than 100 μm.

7. The thin film type chip device according to claim 1, wherein a thickness of the surface layer is equal to and smaller than 80 μm.

8. The thin film type chip device according to claim 1, wherein the substrate is a ferrite magnetic substrate, and
the coil pattern has a multilayer structure.

9. The thin film type chip device according to claim 1, wherein a surface of the surface layer is coplanar with a surface of the cavity defining pattern.

10. The thin film type chip device according to claim 1, wherein the cavity defining pattern is an external electrode electrically connected to the coil pattern.

11. A method of manufacturing a thin film type chip device, the method comprising:
preparing a substrate;
forming a coil pattern on the substrate;
forming a cavity defining pattern defining a cavity through which a part of the coil pattern is exposed on the substrate;
forming a filling layer in the cavity; and
forming a surface layer on the filling layer.

12. The method according to claim 11, wherein the forming of the surface layer includes filling a pore formed in a surface of the filling layer.

13. The method according to claim 11, wherein the forming of the filling layer includes:
filling a first filler in the cavity; and
planarizing the first filler by using the cavity defining pattern as a polishing stop layer, and the forming of the surface layer includes:
forming a second filler on the filling layer; and
planarizing the second filler by using the cavity defining pattern as a polishing stop layer.

14. The conductive substrate according to claim 11, wherein the filling layer and the surface layer include magnetic particles having sizes from 20 μm to 45 μm, and
the magnetic particle of the filling layer uses a ferrite particle having the same size as the size of the magnetic particle of the surface layer.

15. The conductive substrate according to claim 11, wherein the filling layer and the surface layer include magnetic particles having sizes from 20 μm to 45 μm, and
the magnetic particle of the filling layer uses a ferrite particle having a size smaller than the size of the magnetic particle of the surface layer.

16. The conductive substrate according to claim 11, wherein the preparing of the substrate includes: preparing a ferrite substrate, and
the forming of the coil pattern on the substrate includes:
forming a first pattern on the substrate; and
stacking a second pattern on the first pattern.

17. The conductive substrate according to claim 11, wherein the forming of the surface layer on the filling layer is performed by allowing a surface of the surface layer to be coplanar with a surface of the cavity defining pattern.
